(19) United States
(12) Patent Application Publication
(10) Pub. No.: US 2024/0296188 A1
(43) Pub. Date: Sep. 5, 2024

(54) System and Method for Parsing Regulatory and Other Documents for Machine Scoring Background

(71) Applicant: SOCIAL MARKET ANALYTICS, INC., Chicago, IL (US)

(72) Inventors: Trevor Jerome SMITH, Chicago, IL (US); Umair RAFIQ, Kuala Lumpur (PK)

(21) Appl. No.: 18/268,912

(22) PCT Filed: Dec. 21, 2021
(86) PCT No.: PCT/US21/64733

§ 371 Date: Jun. 21, 2023

Related U.S. Application Data
(60) Provisional application No. 63/128,571, filed on Dec. 21, 2020.

(51) Int. Cl. G06F 16/93; G06F 16/84; G06F 16/906

(52) U.S. Cl. CPC G06F 16/93; G06F 16/84; G06F 16/906

(57) ABSTRACT

A method for parsing a document having a document type, where the document type has a corresponding type structure including a plurality of document components, comprising receiving a new document, determining the document type, and selecting a parser from a plurality of parsers based on the document type. The method continues with parsing the document into a tagged data structure using the selected document parser, where the tagged data structure corresponds to the type structure of the document. The populated tagged data structure is stored in a database and made available over a computer network. In some embodiments, the document converted to simplified XML prior to parsing.

### BACKGROUND

The Security and Exchange Commission (SEC) hosts the EDGAR database, which contains voluminous amounts of documents and data, including annual and quarterly corporate filings, executive employment agreements, and investment company holdings. For example, in 2019, 6660 Form 10-Ks were filed, and 17,969 for 10-Qs were filed. These documents generally follow a form prescribed by the SEC, but may be formatted and filed in different file formats.

Open source tools and databases exist to aid researchers in natural language processing by providing libraries for processing EDGAR filings. They provide open sourced code and documentation on how to update and store a database of metadata and text. One example is OpenEDGAR. However, open sourced solutions like OpenEDGAR only provide the raw text of the document (i.e., document structure text is not distinguished from body text) and put the onus on the user to implement solutions to parse the document in a machine-readable format. This makes it more difficult for a user to access the text of a particular Part or Item of a SEC filing since the text is not parsed according to the document's structure. This also makes it more difficult to perform natural language processing algorithms on particular Parts or Items, which deprives a user of the value within the document since it can only be taken as a whole.

Calculating sentiment from microblogging feeds, such as Twitter, is known. However, tweets are very short messages and are nowhere near the scale of a SEC filing. Also, tweets typically do not have internal organization.

### SUMMARY

A method for parsing a document having a document type, where the document type has a corresponding type structure including a plurality of document components, comprising receiving a new document, determining the document type, and selecting a parser from a plurality of parsers based on the document type. The method continues with parsing the document into a tagged data structure using the selected document parser, where the tagged data structure corresponds to the type structure of the document. The populated tagged data structure is stored in a database and made available over a computer network. In some embodiments, the document converted to simplified XML prior to parsing.

In some embodiments, the document is a multi-level document, with a plurality of high-level document components, each high-level document component comprising a plurality of lower-level document components. Each tag may identify a different document component.

In some embodiments of the above method, sentiment calculated for each document component. Sentiment is calculated independently for lower-level document components, and sentiment from lower-level document components are combined to calculate sentiment for higher level document components.

In some embodiments of the above method, the tagged data structure comprises a JSON object. In some embodiments, the JSON object comprises a nested JSON document object having a plurality of accepted JSON data types corresponding to the document's type structure and the plurality of accepted JSON data types are populated with the document components. In some embodiments, each document component is stored in an accepted JSON data type having a distinct tag identifying the document component. JSON object arrays may also be used in combination with, or in lieu of nested JSON objects.

In some embodiments of the above method, the tagged data structure comprises an XML file or object. In some embodiments, the XML file or object comprises a plurality of nested XML objects, where the XML objects correspond to the document's type structure, the XML objects being populated with the document components. In some embodiments, the XML file is a flat file comprising data tags and hierarchy that corresponds to the type structure.

In some embodiments, the document is a SEC filing document, the document type is a type of SEC filing, and the type structure comprises the form required of the SEC filing type. For example, the document type may comprise a SEC Form 10-K, and the type structure comprises the Parts and Items of a SEC Form 10-K. In this example, the tagged data structure comprises a plurality of part tags corresponding to parts in SEC form 10-K, each part comprising a plurality of item tags corresponding to items in SEC form 10-K. In the embodiment comprising a nested JSON object, each part and item is stored in nested JSON component objects.

In some embodiments of the above method, the parser is configured to discard unwanted document components. The parser may also check the document checked for required parameters and/or missing or erroneous parameters or components, and report any anomalies.

In another embodiment, a method of generating sentiment-scores for a document that has been parsed into a hierarchical tagged data structure, the hierarchical tagged data structure having a plurality of high-level tags, each of the plurality of high-level tags having lower-level tags, each of the lower-level tags identifying content from the document, the method comprising calculating sentiment for each lower-level tag, calculating sentiment for each high-level tag by summing sentiment for the low-level tags within each high-level tag, and calculating document sentiment by summing sentiment for the high-level tags, and storing each calculated sentiment value. In some embodiments, additional levels exist between the lower-level tags and the high-level tags. This method may advantageously be used in combination with any of the methods for parsing documents disclosed above.

The above method, where the document comprises a SEC filing, and the high-level tags and lower-level tags correspond a heading in a SEC form. In some embodiments, stored sentiment for a given tag is retrieved for a plurality of documents, each of the documents having a different filing date. In some embodiments, stored sentiment for a given tag is retrieved for a plurality of documents, each of the documents having a different filing entity.

### BRIEF DESCRIPTION OF THE DRAWINGS

FIG. 1 is a block diagram of the system architecture of the document parsing system according to one example of the present invention.

FIG. 2 is a block diagram of the system data flow according to one example of the present invention.

FIG. 3a is a block diagram of a Parser stage according to one example of the present invention.

FIG. 3b is a block diagram of a Parser selection stage according to one example of the present invention.

FIG. 4 is a block diagram of an Evaluator stage according to one example of the present invention.

FIG. 5 is a block diagram of a Calculator and Comparator stage according to one example of the present invention.

FIG. 6 shows a schema of a Private and Public database which may be used in one example of the invention.

FIG. 7 is a block diagram of one example of the Parser stage according to a PDF report example of the present invention.

FIG. 8 shows the result of an analysis of calculating the file reduction size of the original source document compared to the parsed textual JSON version from July to September 2020.

FIG. 9 is a table outlining the Part and Item structure of Form 10-K, as mandated by the Securities and Exchange Commission.

FIG. 10 is a table outlining the Part and Item structure of Form 10-Q, as mandated by the Securities and Exchange Commission.

FIG. 11 is a table outlining the Part and Item structure of Form 8-K, as mandated by the Securities and Exchange Commission.

FIG. 12 is a table outlining the Part and Item structure of Form 20-F, as mandated by the Securities and Exchange Commission.

FIG. 13 is an example of a typical table of contents of Form 10-K taken from NIKE Inc.'s 2020 Form 10-K, retrieved from SEC EDGAR website.

FIG. 14 contains two views of a parsed JSON object expanded to show two levels of detail outlining the parsed textual version of one example of a Form 10-K from FIG. 13

FIGS. 15a-15c show the partial contents of the Risk Factors (Part 1, Item 1A) section taken from NIKE Inc.'s 2020 Form 10-K, retrieved from SEC EDGAR website.

FIG. 16 contains a view of the same JSON object as in FIG. 14 expanded to show in detail the SectionText field of Part 1 Item 1A (Risk Factors), which corresponds to the contents in FIGS. 15a-15c.

FIG. 17 is an example of a table of contents for an Annual Report taken from NEOCHIM AD's 2020 Annual Report for the 2019 fiscal year.

FIG. 18 contains a view of a parsed JSON object for the Annual Report shown in FIG. 17 expanded to show the level where each nested JSON object corresponds to each section of the table of contents.

FIG. 19 shows the partial contents of the Sections 1 and Section 2 taken from NEOCHIM AD's 2020 Annual Report for the 2019 fiscal year.

FIG. 20 contains a view of the same JSON object as in FIG. 18 expanded to show in detail the SectionText field of Section 1 and 2, Background and Corporate Information and Summary of the Significant Account Policies of the Company, which corresponds to the contents in FIG. 19.

### DETAILED DESCRIPTION

Various aspects of the invention in the examples generally relate to processing of regulatory documents required by the United States Securities and Exchange Commission (SEC) and specifically to the parsing of these documents into a machine-readable format using the generally accepted document structure requirements from the SEC. One particularly advantageous domain of application is natural language processing (NLP), which is a sub-field of linguistics and artificial intelligence concerned with processing and analyzing large of amounts of natural language data. In the case of regulatory filings, the invention provides a framework for a user to apply NLP techniques on a machine-readable version of the regulatory filing in order to interpret some signal for the stocks of the companies as expressed in the regulatory filing. This framework may be extended to other types of long-form text documents without a pre-defined document structure like regulatory filings, such as healthcare, law, and academia, where a machine-readable (structured) version of text could be useful for better understanding of text at scale. In these applications, the invention will not need pre-determined inputs to organize the machine-readable version of the document; instead, the invention will utilize the actual structure of the document (i.e., table of contents; or the titles, sub-titles, sections, sub-sections) to organize the machine-readable version of the document.

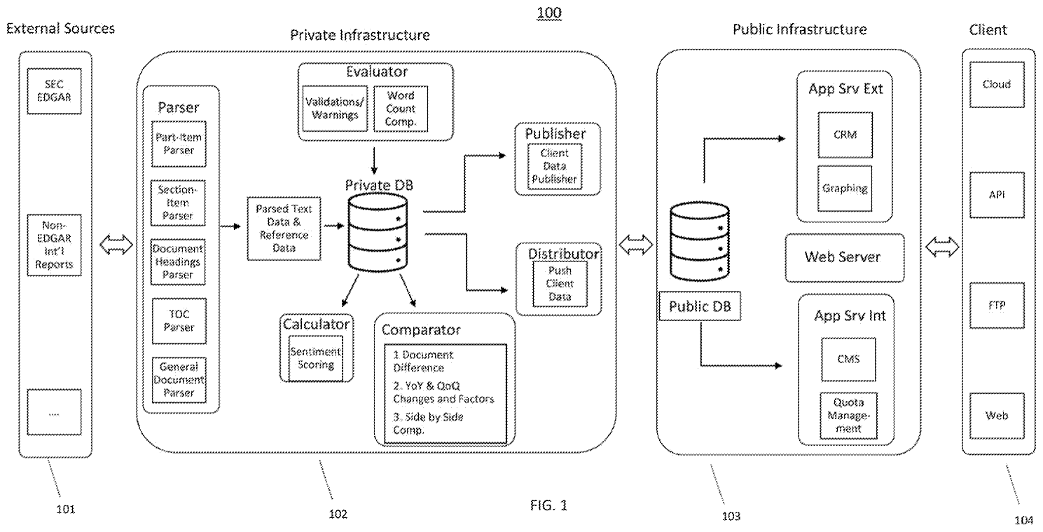

FIG. 1 shows the block diagram 100 of one example of system architecture of a document parser, sentiment calculator, and comparator system of the present invention. The architecture comprises a Private Infrastructure 102 and Public Infrastructure 103. In some embodiments, the Private Infrastructure 102 comprises a general-purpose computing system and/or network accessible computer server configured with a relational database, such as a MySQL database. The Private Infrastructure 102 collects formal documents corresponding to a subject of interest. In one advantageous example, the subject of interest corresponds to regulatory filings of publicly traded entities. Subjects of interest may be defined by a Universe of publicly traded companies. In some embodiments, the Universe is an extended set of publicly traded companies modeled after the S&P 500 Index. In other embodiments, the Universe comprises other sets of publicly traded companies. The Private Infrastructure 102 may be queried for a given type of filing for a given time to pull parsed text versions and sentiment metrics of the Universe's regulatory filings. Stock pricing data for members of the Universe may be obtained by querying Quandl or other suitable information source. The Private Infrastructure 102 parses regulatory filings; evaluates the parsed text for accuracy; calculates sentiment and comparator metrics; stores the parsed text and sentiment and comparator metrics in a relational database; and distributes the stored information to the Public Infrastructure 103 for public client access and also publishes the information via API for private client access.

The Public Infrastructure 103 maintains a relational database of parsed text, sentiment scoring and comparator metrics and enables public client access 104 to real-time and historical data of the complete Universe of public company regulatory filings. The relational database may comprise a MySQL database or any other suitable relational database. The Public Infrastructure 103 may also comprise a web server configured with HTML code stored in non-volatile storage or memory. Public clients are able to access parsed textual data, and sentiment and comparator metrics using a web browser interface using various devices. They may also choose to receive daily reports via email on the latest regulatory filings to be submitted to the SEC, receive alerts for when a public company of their interest submits a filing, or receive alerts when a public company of their interest submits a filing with a sentiment score in their target value or with a change from previous filing in their target value. They can also choose to receive historical data via an FTP interface or a cloud-based data warehousing tool such as Snowflake.

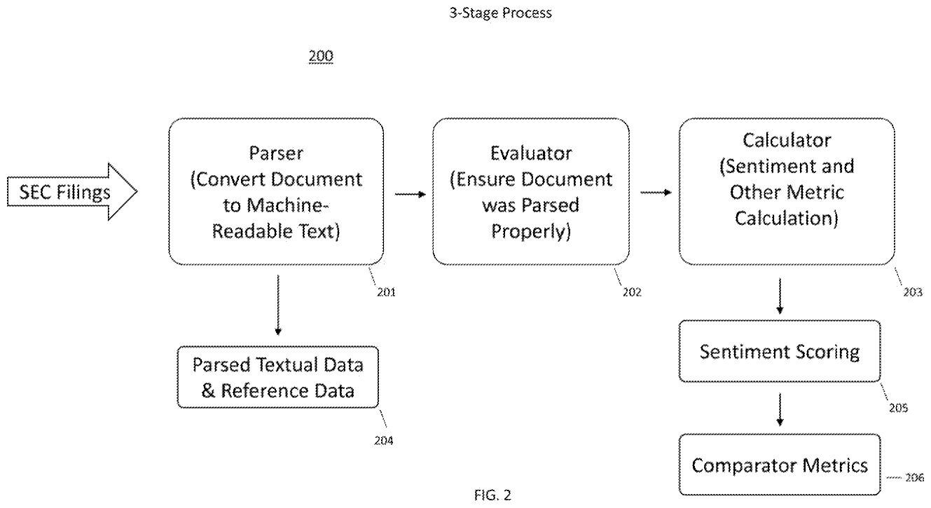

FIG. 2 is a data flow diagram 200 to illustrate the three stages employed by some embodiments to transform a formal document into machine-readable parsed text and the corresponding calculations on that parsed text-sentiment and comparator metrics. “Machine-readable” in this context means structured data formatted to be processed by a variety of operating systems and software applications without intermediate conversion step(s). In preferred embodiments, as explained in more detail below, certain portions of the structure are derived from a source document, a required filing format, or both.

The Parser 201 receives documents from the source and converts the original document into a corresponding machine-readable parsed version. These parsed versions of text and reference metadata are populated in tables in the Private database. The Evaluator 202 analyzes the parsed text and ensures the document was parsed properly according to a system of validations for completeness and accuracy and comparisons made against the original document. When the parsed text passes through the validations, the Calculator 203 scores the parsed document for sentiment and establishes comparator metrics for this document based on the previously released document (the next-most recent document of the same type) from the public company. These metrics are then stored in the Private database. The Parser 201, Evaluator 202, and Calculator 203 may be implemented as JAVA applications. Other programming environment or languages suitable for interfacing with a relational database may also be used.

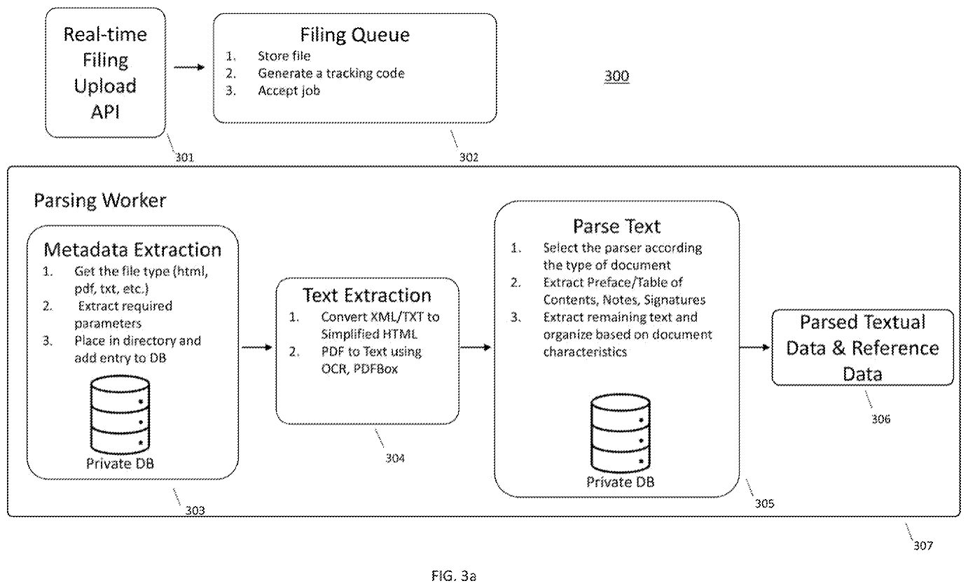

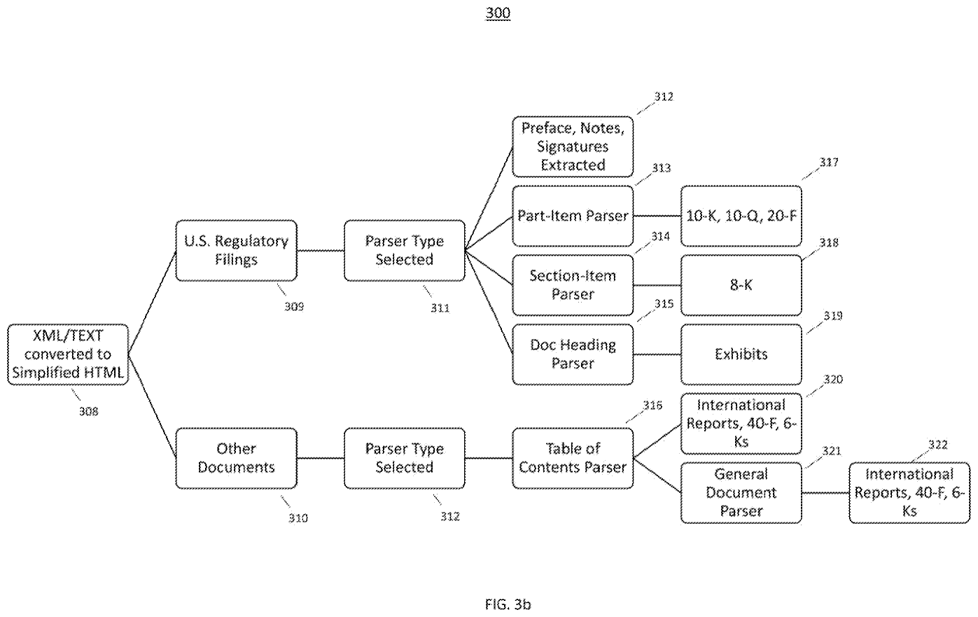

FIG. 3a presents detail on the Parser stage 300 of the processing pipeline. The Filing Queue 302 continuously polls the Real-time Filing Upload API 301 for the most updated filings submitted to the SEC. These original documents are stored, the type of file is determined to ensure that the file is acceptable, a unique tracking code is created and the file is added to the queue to be processed by the Parsing Worker 307. The Parsing Worker 307 begins with Metadata Extraction 303. First the type of file (HTML, PDF, txt, etc.) is extracted from the file in the job, then it extracts the required parameters needed later for parsing selection, and then adds the entry to the Private Database. Next, the Text Extraction 304 stage converts the original document into Simplified XML or HTML and text files or converts PDF files to text using open source tools such as Apache's PDFBox and Optical Character Recognition (OCR). Finally, in the Parse Text 305 stage, a parser is selected to parse the extracted text using the metadata and parameters extracted in the Metadata Extraction 303 stage. When the Parsing Worker 307 is complete this concludes the Parser stage 300 of the processing pipeline.

In some embodiments, the extracted text is parsed into a machine-readable, nested JSON object preserving the same structure as the original document and/or form on which the original document is patterned. JSON objects use “keys” or “tags” to impart structure to data so that it is machine-readable. In examples explained in more detail below, the tags comprise heading tags which reflect the structure of the original document. JSON objects are advantageous because data can selectively retrieved by key or tag by querying the object using standard programming methods. While JSON objects are one form of tagged data structure disclosed herein, other types of tagged structured data objects and files may be employed. For example, XML files may be used, with or without nested XML data objects.

FIG. 3b illustrates selection of a Parser 311 & 312 according to a type of U.S. SEC filing or an international company's report according to some embodiments of the present invention. For example, after the Preface, Notes and Signatures are extracted 313, a Part/Item Parser 314 is selected for 10-K, 10-Q, and 20-F filings, a Section/Item Parser 316 is selected for 8-K filings, a Document/Heading Parser 318 is selected the Exhibits attached to the regulatory documents. Each form-specific parser is configured to seek Parts, Sections, Items, and other structure found in their respective SEC filing forms. For documents without a predefined structure, such as 6-K and 40-F SEC filings and annual reports, a Table of Contents Parser 320 is selected, which searches the document for a table of contents outlining the structure of the document. If a table of contents is not found, then a General Document Parser 322 is selected for documents without a pre-defined structure.

In preferred embodiments, heading tags are standardized for a document type. For example, the SEC Form 10-K includes a Part I, and Part I includes several “Items,” including Item 1. These portions may be assigned heading tags of “PI” and I1”, respectively. These heading tags are standardized for all Form 10Ks. This facilitates retrieval of a specific document component for multiple JSON objects using a common heading tag.

Some companies make SEC filings that do not follow standard SEC order. These companies may provide a cross reference index to correlate their filings to the SEC standard forms. The various form parsers may access the cross-reference index and assign the standardized heading tags to appropriate document components based on the cross reference index. In this way, a standardized JSON object is created, even if the document as originally filed was not standard.

Preface, Notes to Consolidated Financial Statements, and Signatures are extracted first and removed from rest of document to be parsed separately. Header tags for these components may also be standardized. Then, document components, such as Parts, Items, Sections, etcetera are individually parsed into a tagged, hierarchical data structure, such as a JSON object, In some embodiments, automated validations determine parsing errors and validate that SEC guidelines are followed; all elements of a document are covered: parts, items, notes, and signature; required portions of document (i.e., text) have all been parsed; un-wanted portions of document are not included in parsed JSONs such as tables, banners, repeating headings and page numbers; and inconsistent formatting is normalized to provide consistent readability for end-users. The end-user is notified of missing or unexpected elements in document (e.g., an added item that doesn't appear in SEC guidelines).

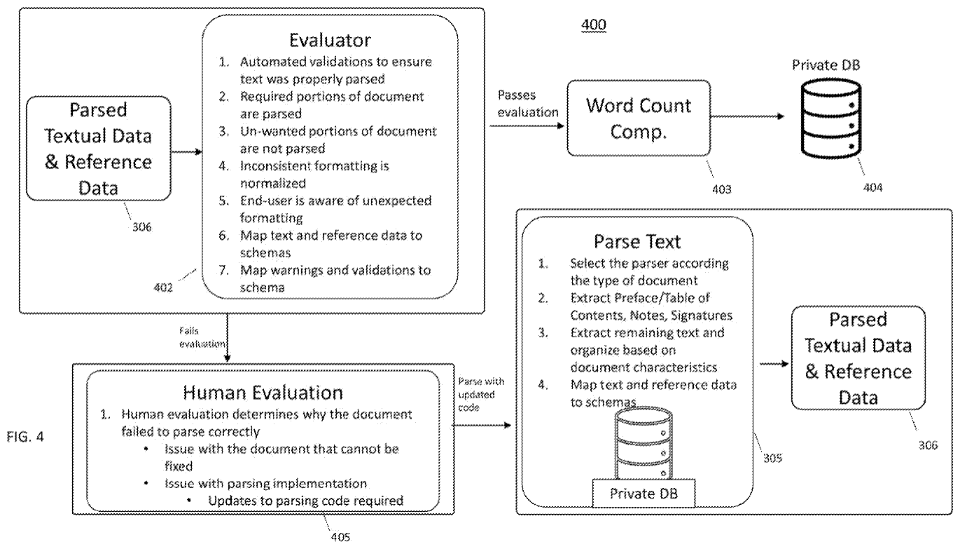

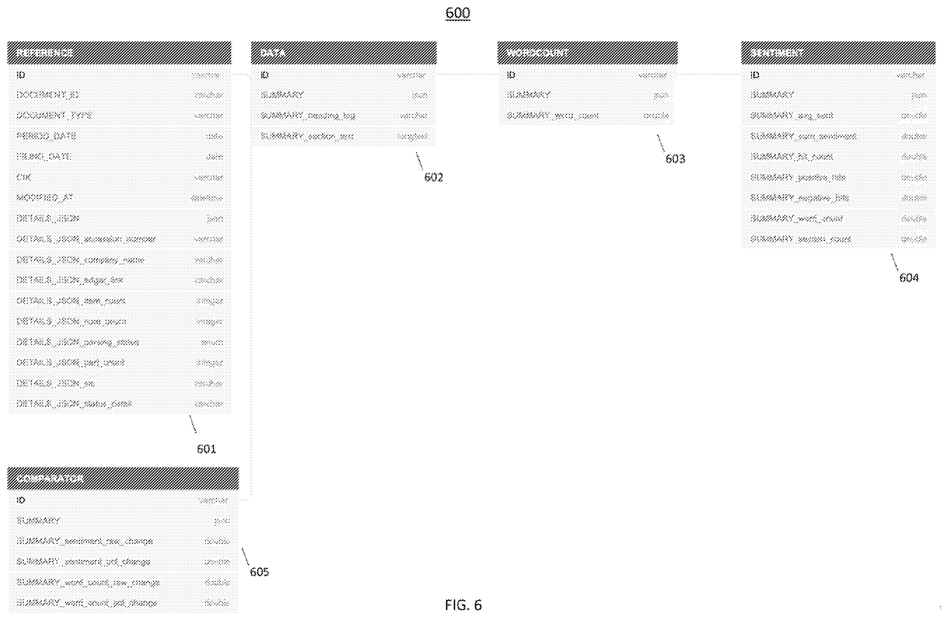

FIG. 4 presents detail on the Evaluator stage 400 of the processing pipeline. The parsed text data and reference metadata 306 enters the Evaluator stage 402 where automated validations ensure the text was properly parsed according to specifications. These include determining whether required portions of the original document are parsed in the JSON object and ensuring un-wanted portions of the original document are not. If there is inconsistent formatting in the original document that has been previously documented, then these are normalized in to the JSON object and the end-user will be aware of the unexpected formatting in the reference metadata. If the document passes evaluation, word count comparison data 403 and the parsed text and reference metadata are stored in the Private database 404. In FIG. 6, a condensed database schema shows the data models for the reference metadata, the parsed text data, and the sentiment metrics. After a document's parsed text passes the evaluation stage, the reference metadata is stored in the Reference table 601 and the parsed text is stored in the Data table 602.

In the event that the parsed text fails evaluation, it enters the Human Evaluation 404 stage of the process. Here, a person skilled in the development of one or more parsing implementations will determine why the document failed to parse correctly. The skilled person will determine if the issue causing failure was because of the original source's document structure and determine if the anomaly is a true issue or whether the issue can pass on to the Private DB 403 with additional warnings added to the reference metadata for the user. If the expert determines the issue is with the parsing implementation, the updates to the parsing code are required. When the updated parsed code is implemented, the document will again enter the Parse Text 305 step of the Parser stage 300 and return parsed text data and reference metadata 306, which will enter the Evaluator stage 400 again and start the evaluation process over again.

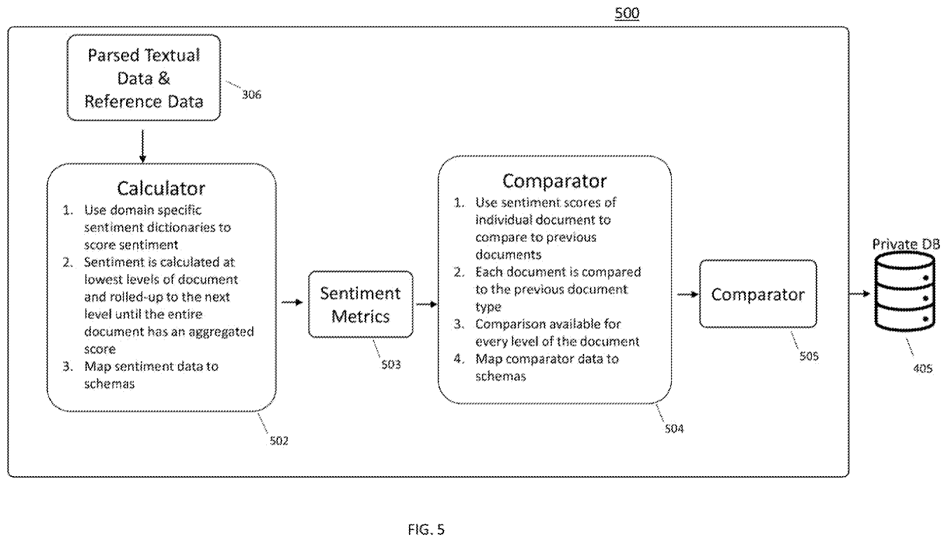

FIG. 5 presents detail on the Calculator stage 500 of the processing pipeline. The input from this stage is the parsed text data and reference metadata 306 from the Parser stage 300. This input has also passed the Evaluator stage 400 and been added to the Private database In the Reference table 601 and Data table 602. The parsed text data and reference metadata enter the Calculator step 502, where the content of parsed text is evaluated and the sentiment value for each word or phrase is obtained from a Domain Specific Sentiment Dictionary. In some embodiments, a Sentiment Dictionary is tuned for performance in the financial domain. This may have applications in regulatory filings, company annual reports, and business news sources. Additional domains may include politics/elections, political science, economics, consumer products, etc.

Each level of the document receives a sentiment scoring. The text in the lowest, most granular levels the documents is scored for sentiment and these levels are combined together to form the sentiment of the next-highest level in the document. This process continues until the level of the document is the entire document itself.

Thus, for the lower level containing n identified words and m identified multi-word phrases, the sum of sentiment for that level is:

$${Sentiment}_{lower level} = {\sum }_{i = 1}^{n} {Sentiment}_{word} ( i ) + {\sum }_{j = 1}^{m} {Sentiment}_{phrase} ( j ) \qquad Equation ( 1 )$$

Sentiment_{word} and Sentimentₚₕᵣₐₛₑ are the sentiment values for a word or phrase in the lower level obtained from a Domain Specific Sentiment Dictionary.

From this, the sum of sentiment for the next-highest level is the sum of the lower levels' sentiment for each lower level in the next level up, where the number of lower levels contained in the next level up is n. This is represented mathematically as:

$${Sum\_Sentiment}_{next level up} = {\sum }_{i = 1}^{n} {Sentiment}_{lower {level}_{i}} \qquad Equation ( 2 )$$

$$where n = number of lower levels in the next level$$

The average sentiment for the next-highest level is the sum of the lower levels' sentiment divided by the number of lower levels in the next level up where n is the number of lower levels contained in the next level is n.

$${Avg\_Sentiment}_{next level up} = \frac{{\sum }_{i = 1}^{n} {Sentiment}_{lower {level}_{i}}}{n} \qquad Equation ( 3 )$$

$$where n = number of lower levels in the next level$$

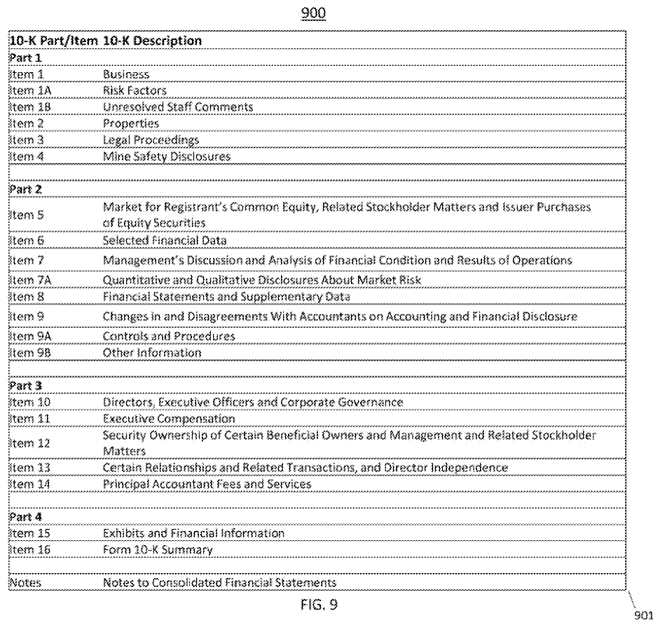

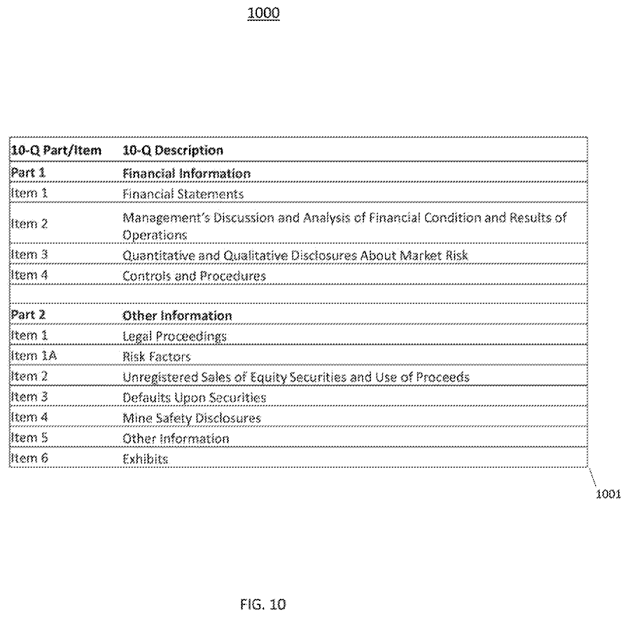

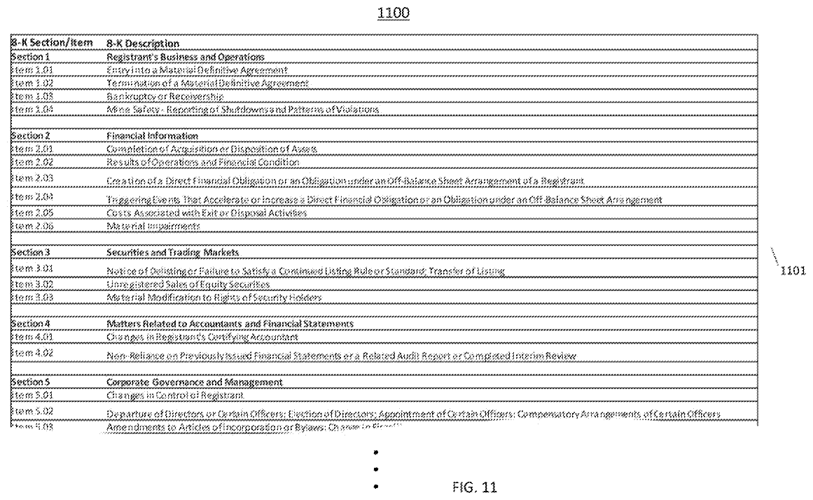

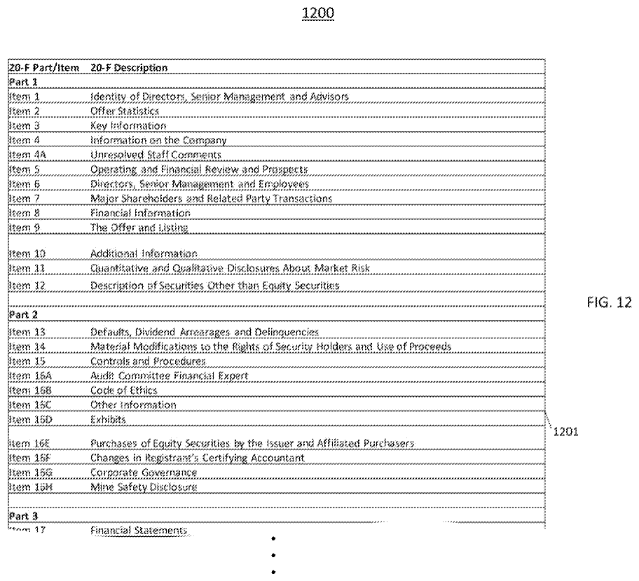

Depending on the document, the “lower level” and “next level up” mean different things based on how the document itself is organized. In the case of SEC regulatory filings, outlined in FIG. 9 through FIG. 12, the primary levels of the filing are the entire document, the Parts within the entire document, the Items within each Part, and the sub-sections within each Item. Thus, the lowest levels of the filing are the sub-sections beneath each Item; each Item would be the next level up from the sub-sections; aggregated together the next level up from the Items is the Part; and, aggregated together, the next level up from the Parts is the entire document.

Expressed mathematically, the sum of sentiment for a sub-section containing n identified words and m identified multi-word phrases is,

$${Sentiment}_{sub\_section} = {\sum }_{i = 1}^{n} {Sentiment}_{word} ( i ) + {\sum }_{j = 1}^{m} {Sentiment}_{phrase} ( j ) \qquad Equation ( 4 )$$

The sum of sentiment for the next level up from a sub-section, an Item, is the sum of Sentiment_{sub-section} for all sub-sections in the Item. Expressed mathematically,

$${Sum\_Sentiment}_{Item} = {\sum }_{i = 1}^{n} {Sentiment}_{sub - {section}_{i}} \qquad Equation ( 5 )$$

$$where n = number of sub - sections in an Item$$

The average sentiment for the next level up of the sub-section, an Item, is the sum of Sentiment_{sub-section} for all sub-sections in the Item (i.e., the result of Equation (5), Sum_Sentiment_{Item} ) divided by the number of sub-sections in the Item. Expressed mathematically,

$${Avg\_Sentiment}_{Item} = \frac{{\sum }_{i = 1}^{n} {Sentiment}_{{sub\_section}_{i}}}{n} \qquad Equation ( 6 )$$

$$where n = number of sub - sections in an Item$$

The sum of sentiment for the next level from an Item, a Part, is the sum of Sum_Sentiment_{Item} for all Items in the Part. Expressed mathematically,

$${Sum\_Sentiment}_{Part} = {\sum }_{i = 1}^{n} {Sum\_ Sentiment}_{{Item}_{i}} \qquad Equation ( 7 )$$

$$where n = number of Items in an Part$$

The average sentiment for the next level up from an Item, a Part, is the sum of Sum_Sentiment_{Item} for the number of Items in the Part (i.e., the result of Equation (7), Sum_Sentiment_{Part}) divided by the number of Items in the Part. Expressed mathematically,

$${Avg\_Sentiment}_{Part} = {\sum }_{i = 1}^{n} {Sum\_ Sentiment}_{{Item}_{i}} \qquad Equation ( 8 )$$

$$where n = number of Items in an Part$$

The sum of sentiment for the next level from a Part, the entire filing, is the sum of Sum_Sentiment_{Part} for all Parts in the Document. Expressed mathematically,

$${Sum\_Sentiment}_{Filing} = {\sum }_{i = 1}^{n} {Sum\_ Sentiment}_{{Part}_{i}} \qquad Equation ( 9 )$$

$$where n = number of Parts in a filing ( n includes Exhibits and Notes to Consolidated Financial Statements )$$

The average sentiment for the next level up from a Part, the entire filing, is the sum of Sum_Sentiment_{Part} for the number of Parts in the filing (I.e., the result of Equation (9), Sum_Sentiment_{Filing}) divided by the number of Parts in the filing (including the Exhibits and the Notes to Consolidated Financial Statements, which are considered the same level as a Part). Expressed mathematically,

$${Avg\_Sentiment}_{Filing} = \frac{{\sum }_{i = 1}^{n} {Sum\_ Sentiment}_{{Part}_{i}}}{n} \qquad Equation ( 10 )$$

$$where n = number of Parts in a filing ( n includes Exhibits and Notes to Consolidated Financial Statements )$$

The other fields derived from the Calculator step 502, in addition to sum of sentiment and average sentiment, are hit count, positive hits, negative hits, word count, and section count. Hit count is the number of identified words and phrases identified by the Domain Specific Sentiment Dictionary in the specified level of the text. Positive hits are the number of identified words and phrases identified by the Domain Specific Sentiment Dictionary in the specified level of the text with a sentiment greater than 0. Negative hits are the number of identified words and phrases identified by the Domain Specific Sentiment Dictionary in the specified level of the text with a sentiment less than 0. Word count is the number of total words in the specified level of the text. Section count is the number of levels contained within the specified level of the text. These metrics are collected and stored in Sentiment Metrics 503. Techniques as used in U.S. Pat. No. 9,104,734, which is incorporated by reference, may also be used,

In the case of regulatory filings, each of these metrics is calculated at the sub-section level and then rolled up to the next level until the level reaches the entire filing (Item→Part→Filing). For each level, each metric is stored in the Sentiment Metrics 503.

After the Sentiment metrics 503 have been calculated, the next step in the process is the Comparator step 504. This step takes the newly calculated Sentiment Metrics 503 and compares these metrics to the metrics derived for the previous document the company filed of the same document type. For example, if Company A issued a quarterly report and this document entered the Calculator stage 500, the document would be compared to the Sentiment Metrics 503 of the previous quarterly report Company A filed. These metrics include the raw and percentage change in sentiment metrics and the raw and percentage change in word count metrics for each filing compared to the previously filed filing for each company.

When the Comparator step 504 has completed, the data is aggregated in Comparator 505. Then Sentiment 503 and Comparator 505 are added to the Private database.

This is one example of a set of comparison metrics that can be derived from Sentiment 503. In the SEC regulatory filings example, for instance, a user may use the Sector-Industry Code (SIC) in the Reference data 306 to create comparison metrics comparing how a company's metrics in the Sentiment 503 compare to the other companies in its respective sector or industry. The comparison may be focused on selected parts, sections, or items, or other portions of a document's organization.

In some embodiments, a user also uses the textual data 306 to compare the text of a document to another document and calculate the textual difference between the two as a percentage form using a similarity metric such as cosine similarity. An example of the most effective utilization of this metric for the SEC regulatory filings example would be to compare Company A's most recent Form 10-K document to the previously filed Form 10-K document. This would give a one-number summary of how much Company A's operations have changed in a year by comparing their most recent Form 10-Ks.

FIG. 6 is a condensed database schema showing examples of data models for machine readable data extraction, reference metadata, word count comparison, sentiment scoring, and comparator data. Parsed textual data and reference data 306 populate the DATA 602 and REFERENCE 601 tables. The REFERENCE 601 table contains unique identifiers, features of the document (document type, filing date, etc.), features of the company filing the document (company, CIK code, industry classification), and features related to the parsed text (parsing status, part, item, and note counts). The DATA 602 table contains unique identifiers and a JSON object called SUMMARY containing the detailed heading tag of the level of the document for each object and the parsed text of that level of the JSON tag. The WORDCOUNT 603 table contains unique identifiers and a JSON object called SUMMARY containing the word count for specified level detailed in the JSON field tags. Similarly, the SENTIMENT 604 table contains unique identifiers and a JSON object called SUMMARY containing the sentiment metrics previously detailed for the specified level detailed in the JSON field tags. Finally, the COMPARATOR 605 table contains unique identifiers and a JSON object called SUMMARY containing the word count and sentiment comparison metrics for the specified level detailed in the JSON field tags.

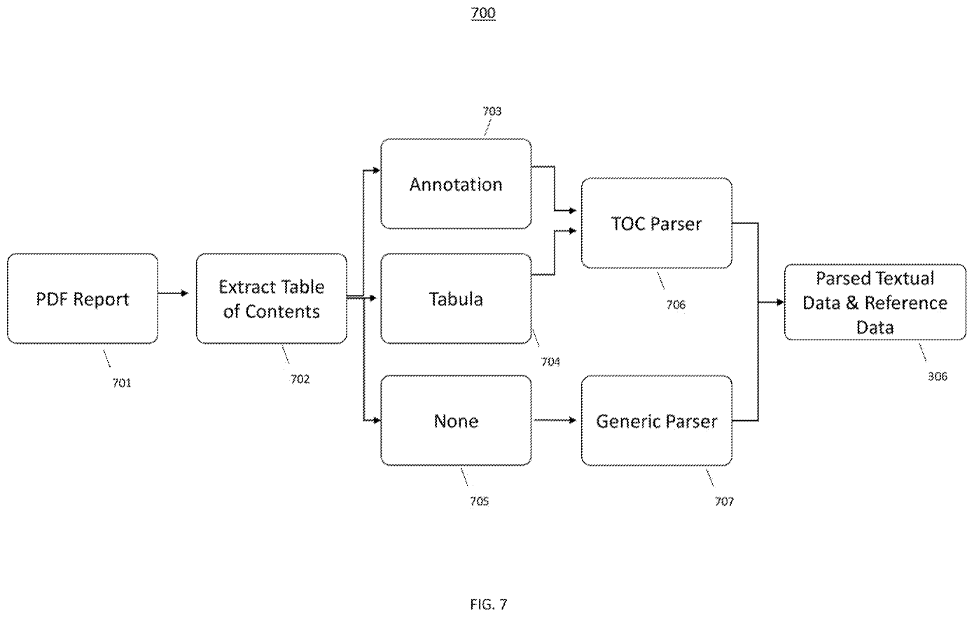

FIG. 7 presents detail on one example of the invention showing the text parsing process of a PDF report 701, such as a glossy-paged company annual report. Unlike a government regulatory filing, these types of documents do not have a defined structure; however, they often have a Table of Contents showing the organization of the document, such as the sections and sub-sections of the document. Extracting the table of contents from the PDF report 702 is a technique used to understand how to parse the document. Using the PDF's Annotation 703 or detecting contents table using Tabula 704 to extract the Table of Contents are two common ways to do this, while instances exist of not being able to extract any Table of Contents information 705. Separate parsers exist for documents with extracted Table of Contents 706 and for documents without one 707. These parsers are part of a collection of parsers that are chosen during step one of the Parse Text step 305 in 300. The end result of this process is the Parsed Textual Data and Reference Data 306 and will proceed to the Evaluator stage of the process 400.

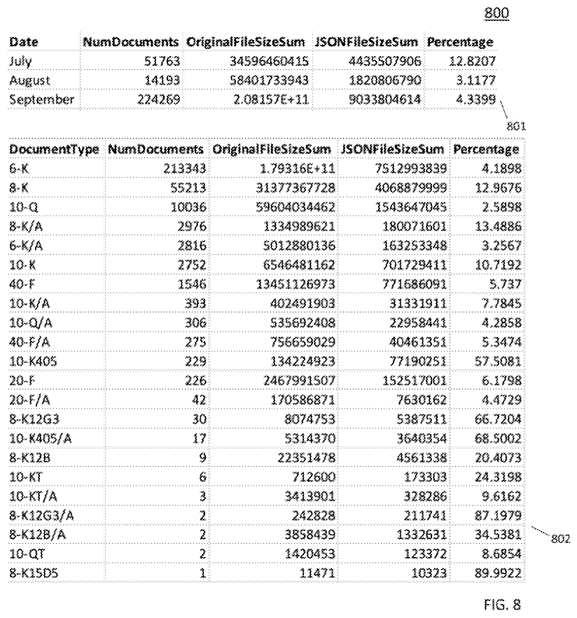

FIG. 8 presents an analysis, shown in two tables, of how the invention reduces the size of the source documents, leading to better efficiencies in computer processing. The total number of source documents were counted, the total size of those documents in their original state were summed, and the total size of the parsed JSON version of those documents were queried from the Private database. In 801, these figures are grouped by month and the Percentage field shows the proportion of the total size of the parsed JSON version to total size of those documents in their original state. In August 2020, for example, the total size of the parsed JSON versions of the documents sourced that month was approximately 3.12% of the total size of the documents in their original state. This analysis was replicated in 802 for documents sourced from July 2020 to September 2020 grouped by the type of document being parsed. The first row represents 6-Ks, which are an SEC filing used by certain foreign private issuers to provide information that is:
Required to be made public in the country of its domicile
Filed with and made public by a foreign stock exchange on which its securities are traded
Distributed to security holders.

In this case, the total size of the parsed JSON versions of the 6-Ks sourced from July-September was approximately 4% of the total size of the documents in their original state.

FIG. 9 through FIG. 12 are tables sourced from the SEC's website detailing the document structure of Forms 10-K, 10-Q, 8-K, and 20-F. When compiling these filing types, public companies may have some variability in their document (e.g., company branding), but the content itself should be organized in according to the document structure mandated by the SEC. Forms 10-K, 10-Q, and 20-F are broken down into Parts and those Parts are further broken down into Items. Form 8-K is broken down into Sections and those Sections are further broken down into Items. In contrast to the other filing types, the nature of Form 8-K is such that only the Items relevant to the reason(s) the public company is filing will be filled out and the other Items will not be addressed. Forms 10-K, 10-Q, and 20-F will typically have all the Items populated and if the Item is not relevant for the public company, then there will usually be an acknowledgement as to why that Item was not relevant for the public company.

In 901, Form 10-K's first Part contain Items detailing information about the company such as the description of the business, risk factors to the business and industry, legal proceedings, etc. The second Part contains Items detailing the financial information of the company and references the notes to the consolidated financial statements. The third Part contains Items detailing executive structure and compensation along with other security ownership information. The final Part contains Items summarizing the document and detailing the Exhibit tables. In 1001, Form 10-Qs first Part contains Items detailing the financial information of the company and references the notes to the consolidated financial statements. The second Part contains Items detailing information about the company, risk factors, and legal proceedings, etc., though in less detail than Form 10-K. Form 8-K is structured much differently than Form 10-K and 10-Q because Form 8-K is filed according to need (i.e., when a company has some kind of update falling under the requirements to be filed with the SEC). In 1101, the structure of Form 8-K is outlined containing nine Sections with various related Items within the Sections. The nine Sections cover the following topics:
1) Registrant's Business Operations
2) Financial Information
3) Securities and Trading Markets
4) Matters Related to Accountants and Financial Statements
5) Corporate Governance and Management
6) Assets-Backed Securities
7) Regulation FD
8) Other Events
9) Financial Statements and Exhibits

In 1201, the structure of Form 20-F contains three Parts with information related to the company and financial situation, credit and corporate governance of the company, and financial statements and Exhibit tables. Each of these broader categories contain Items with sub-information related to the Parts.

Parser stage 300 not only converts the text from a source document such as an SEC regulatory filing into a JSON-based machine-readable format, but also preserves the general organization of the source document by creating nested JSON objects within the JSON object mimicking the organization of the source document's various sections and sub-sections. Thus, this machine-readable version of the document not only makes computing natural language processing algorithms easier (and in a more cost-effective manner), but also preserves the original structure of the document allowing for even more targeted analysis,

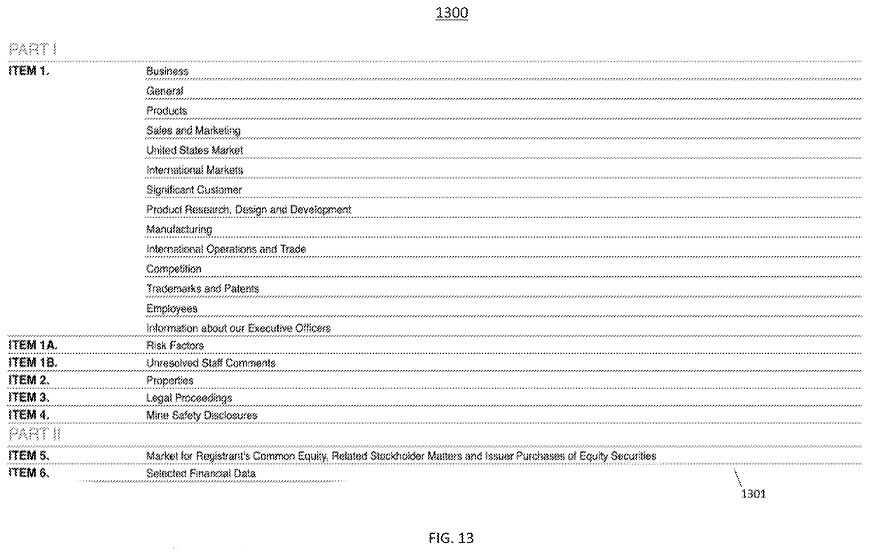

FIG. 13 contains the structure of NIKE Inc.'s Form 10-K 1301 filed in 2020. As required by the SEC, this document follows the structure outlined in 901 for Form 10-K almost to the word. The document is split into four Parts each containing the Items in each Part as outlined in 901.

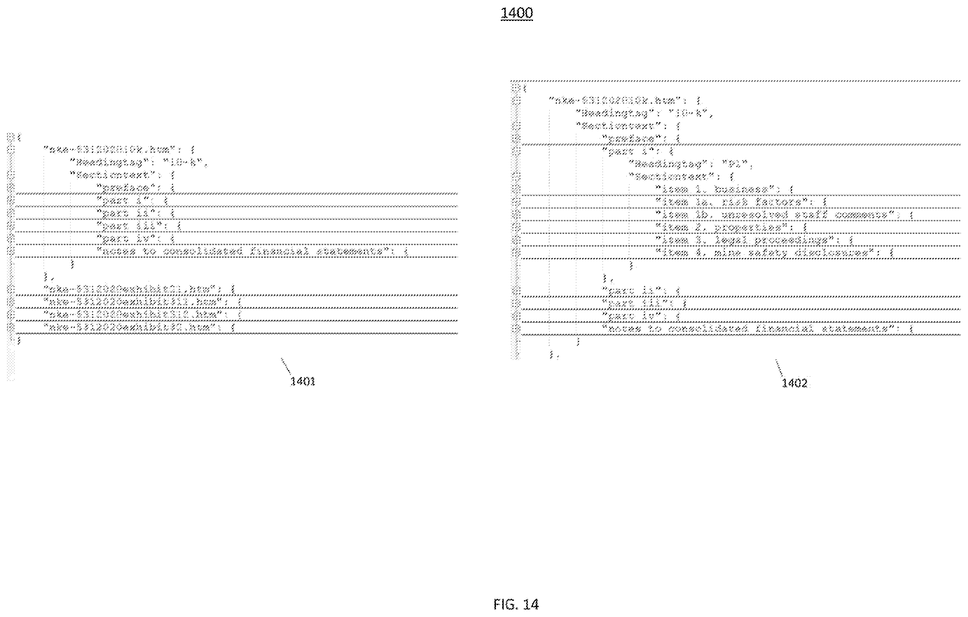

FIG. 14 contains two views of the parsed machine-readable JSON object version of NIKE Inc.'s Form 10-K filed in 2020. 1401 shows the first nested JSON object expanded within the object detailing the four parts of the document, each of which is a nested JSON object. 1402 shows the nested JSON object representing Part 1 expanded detailing the six items, each of which is a nested JSON object. This machine-readable JSON object is an example of an entry in the DATA 602 database table.

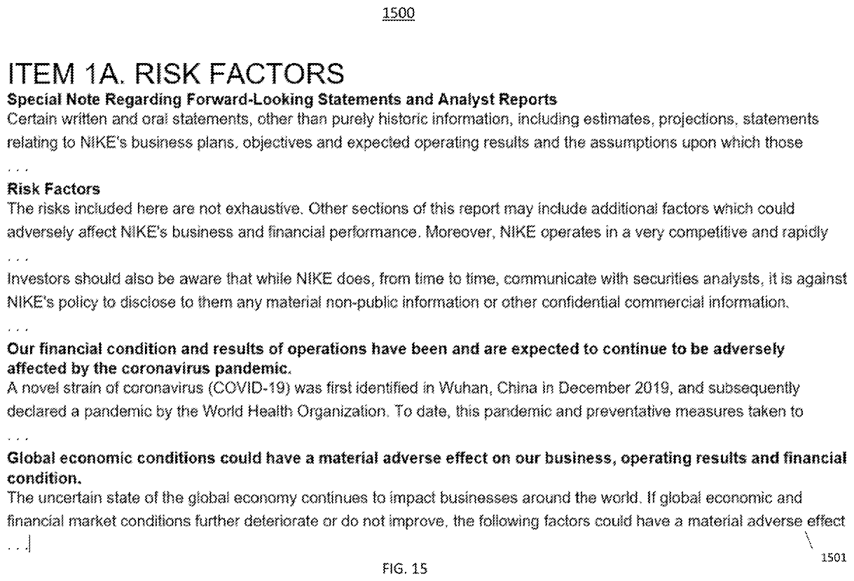

FIG. 15 illustrates partial contents of the Risk Factors section (Part 1→Item 1A) of the NIKE Inc.'s Form 10-K detailed in 1301. In this example, each individual risk factor for the company is written out in orange bold text with information for each risk factor beneath. Each of these risk factors are considered the sub-sections of this Item; thus, these are be considered the lowest level of the document for this Item.

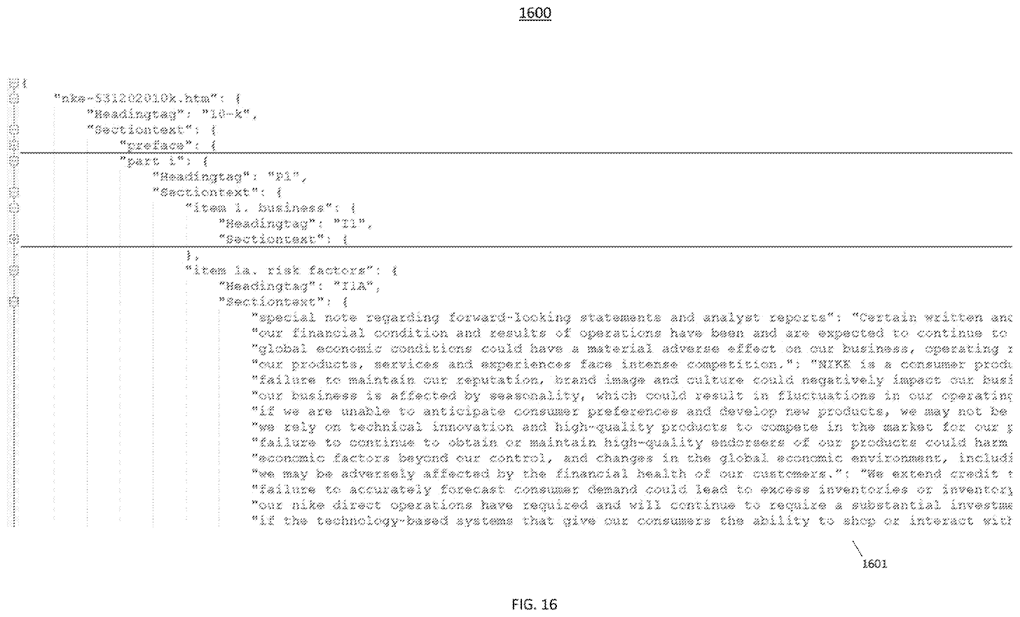

FIG. 16 contains a view of the parsed machine-readable JSON object for NIKE Inc.'s FORM 10-K with the nested JSON object Part 1 expanded and the nested JSON object Item 1 A (nested beneath the Part 1 object) expanded. 1601 shows the nested JSON objects expanded to the point where text corresponding to the content in 1501, 1502, 1503 are parsed. In this nested object, there are bolded tags, which directly match the sub-sections of the Item. For example, the heading tag for Part 1 of the 10-K is “P1”. The heading tag for Item 1A is “I1A”. Item 1A is nested within Part 1. Using this nested JSON object structure and tags representing the sub-sections of each Item, in the case of SEC regulatory filings, a user could choose to narrow their analysis of the parsed, machine-readable text to a particular Part(s), Item(s) with a Part, or even sub-section(s) of an Item because it directly matches the formatting of the original document. For example, Risk Factors (Item 1A in a form 10-K) can readily be extracted from a plurality of filings objects. The plurality of filing objects, for example, may comprise multiple 10-Ks for a single company over the years, or multiple 10-Ks for a single year over an industry sector. In some embodiments, the XML structure of the original document contains file metadata and list of text in HTML format. In some embodiments, the text is formatted with HTML tags that describe its font sizes and weight. The process uses these tags to extract the text between tags to relate to the corresponding heading in a proper document flow and then construct the corresponding object in hierarchy of the JSON structure define by document type standards. Document type standards are defined in FIG. 9-FIG. 13. In some embodiments, the process identifies the relevant hierarchy based on textual mapping when such tags do not exist. In other embodiments where there is no pre-defined document type standard, the process uses HTML tags such as font sizes, weight, color, and indentation or table of contents hyperlinks to create document levels that will construct the corresponding object in the hierarchy of the JSON.

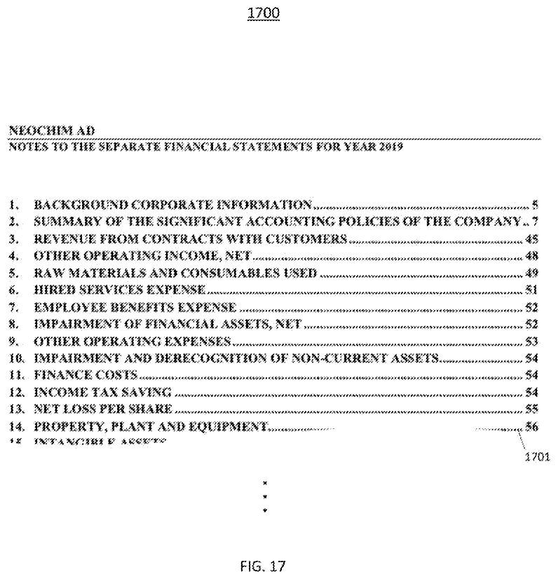

FIG. 17 contains the structure of the table of contents 1701 of NEOCHIM AD's 2020 Annual Report for the 2019 fiscal year. There is no mandated structure on how an annual report must be organized for an international company. Thus, when a document type like this is evaluated by the Parsing process 300, there are no mandates to which sections are expected in the document. A PDF report like this would be evaluated according the PDF parser process 700, which strives to extract the document's table of contents from the PDF's underlying formatting 702 and parse the document according to this extracted table of contents using the Table of Contents Parser 706. If a table of contents cannot be extracted from the PDF, then the document is parsed using the General Parser 707.

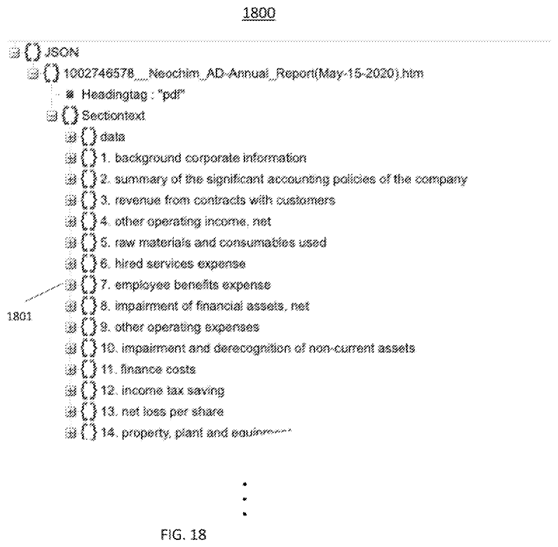

FIG. 18 shows the machine-readable JSON object 1801 resulting from the PDF parser process 700 on the document described in 1701. This JSON object contains nested JSON objects corresponding to the forty-two sections in the table of contents of this document. This machine-readable JSON object is another example of an entry in the DATA 602 database table

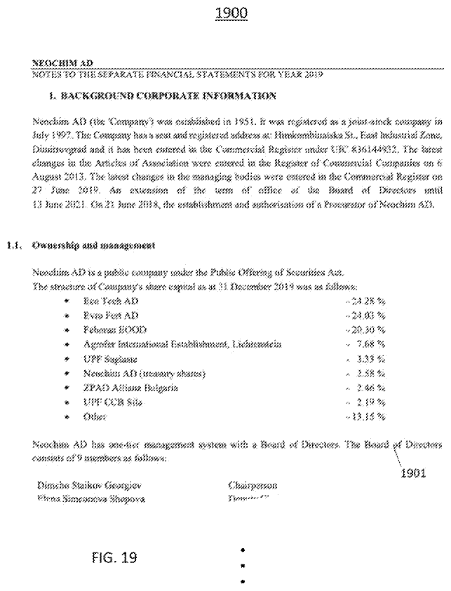

FIG. 19 details the entire first section and the first portion of the second section of the table of contents for the NEOCHIM AD 2020 Annual Report outlined in 1701. Each sub-section in the section for this annual report contains a bolded description and a numeric representation ordering the sub-sections (e.g., 1.1, 1.2, 1.3, 2.1 ) with text beneath detailing the annual report's update on the company's operations with regard to that sub-section.

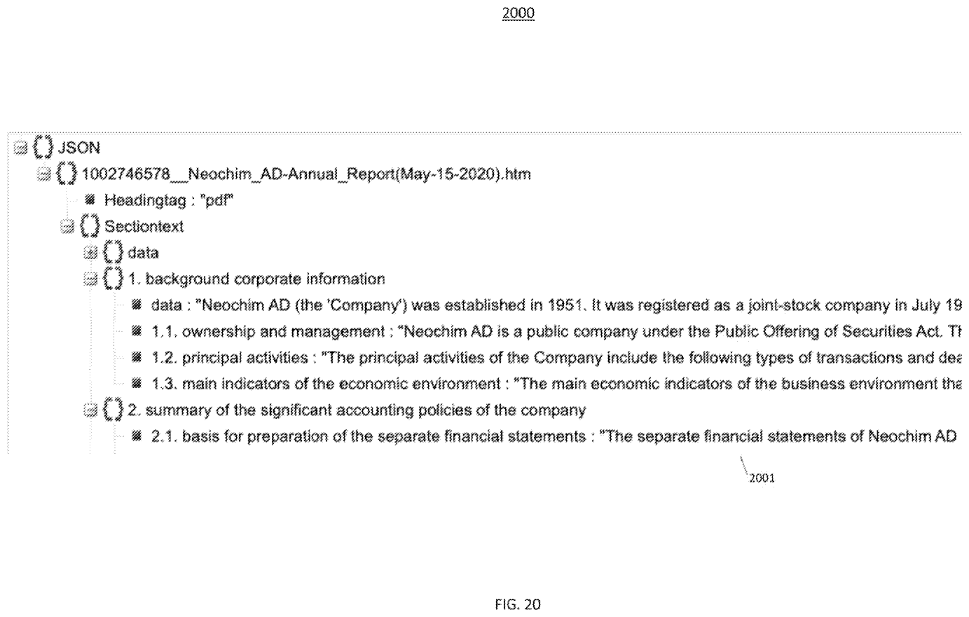

FIG. 20 contains an image of the JSON object introduced in 1801 with the first and second sections expanded to show the tags in those objects representing the sub-sections of the document and the corresponding text of that sub-section, 2001. These sub-sections directly match the bolded numeric sub-section titles show in 1901, 1902, and 1903.

While there is no uniform structure expected from this document like an SEC regulatory filing, the parsing process is flexible enough to structure the machine-readable JSON version of a document in way that preserves the structure of the original document. Just as in the SEC filings example, a user can use the nested JSON structure and corresponding JSON tags to extract only the sections or sub-sections needed for a particular analysis.

The JSON object 2001 contains a structure conducive to applying the previously detailed sentiment metrics. Equation (1) details the calculation of sentiment for the “lower level” of the document containing n identified words and m identified multi-word phrases. In the case of this example, the “lower level” is simply the text beneath the sub-section tags. These sub-sections would be aggregated together to produce the sentiment metrics in 604 for the “next level up,” which would be the section. In this case, there are forty-two sections, and these would be aggregated for the next level up, which would be the entire document itself.

Each document without a pre-defined structure would have a different amount of levels for sentiment calculations, but all documents would follow the same nested structure of calculation as this example based on the nested nature of the JSON object. The various embodiments described herein may be implemented in a wide variety of operating environments, which in some cases may include one or more user computers, computing devices, or processing devices which may be utilized to operate any of a number of applications. User or client devices may include any of a number of general purpose personal computers, such as desktop or laptop computers running a standard operating system, as well as cellular, wireless, and handheld devices running mobile software and capable of supporting a number of networking and messaging protocols. Such a system also may include a number of workstations running any of a variety of commercially-available operating systems and other known applications for purposes such as development and database management. These devices also may include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as TCP/IP stack protocols, FTP, SMB, OSI, HTTP-based protocols, SSL, Bitcoin, Ethereum, blockchain- or smart contracts-supported protocols. Such a network may include, for example, a local area network, a wide-area network, a virtual private network, the Internet, an intranet, an extranet, a public switched telephone network, an infrared network, a wireless network, and any combination thereof. The network may, furthermore, incorporate any suitable network topology. Examples of suitable network topologies include, but are not limited to, simple point-to-point, star topology, self-organizing peer-to-peer topologies, and combinations thereof.

In embodiments utilizing a Web server, the Web server may run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C #or C++, or any scripting language, such as Perl, Python, or TCL, as well as combinations thereof. The server(s) may also include database servers, including without limitation those commercially available from Oracle®, Microsoft®, Sybase®, and IBM®.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the Invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method for parsing a document having a document type, where the document type has a corresponding type structure including a plurality of document components, comprising:
receiving a document;
determining the document type;
selecting a parser from a plurality of parsers based on the document type; and
parsing the document into a tagged data structure using the selected document parser;
the tagged data structure corresponding to the type structure of the document;
storing the populated tagged data structure in a database; and
making the populated tagged data structure available over a computer network.

2. The method of claim 1, further comprising the step of converting the document to simplified XML prior to parsing.

3. The method of claim 1, wherein the document is a multi-level document, with a plurality of high-level document components, each high-level document component comprising a plurality of lower-level document components. Each tag may identify a different document component.

4. The method of claim 1, wherein the tagged data structure comprises one or more of a nested JSON object and JSON object arrays.

5. The method of claim 1, wherein the tagged data structure comprises a nested JSON document object having a plurality of JSON component objects corresponding to the document's type structure and the plurality of JSON component objects are populated with the document components.

6. The method of claim 5, wherein each document component is stored in a distinct JSON component object having a tag identifying the document component.

7. The method of claim 1, wherein the tagged data structure comprises an XML file or object, the XML file or object comprising a plurality of nested XML objects, where the XML objects correspond to the document's type structure, the XML objects being populated with the document components.

8. The method of claim 1, wherein the document is a SEC filing document, the document type is a type of SEC filing, and the type structure comprises the form required of the SEC filing type.

9. The method of claim 8, wherein the type of SEC filing may comprises a SEC Form 10-K, and the type structure comprises the Parts and Items of a SEC Form 10-K;
wherein the tagged data structure comprises a plurality of part tags corresponding to Parts in SEC form 10-K, each part comprising a plurality of item tags corresponding to Items in SEC form 10-K.

10. The method of claim 9, wherein the tagged data structure comprises a nested JSON document object, and wherein each Part and Item is stored in nested JSON component objects.

11. The method of claim 1, further comprising the step of calculating sentiment for each document component.

12. The method of claim 11, wherein the step of calculating sentiment for each document component further comprises the steps of
calculating sentiment independently for each lower-level document component; and
combining sentiment from lower-level document components to calculate sentiment for higher level document components.

13. The method of claim 1, wherein the tagged data structure comprises a hierarchical tagged data structure having a plurality of high-level tags, each of the plurality of high-level tags having lower-level tags, each of the lower-level tags identifying content from the document, the method further comprising the steps of:
calculating sentiment for each lower-level tag;
calculating sentiment for each high-level tag by summing sentiment for the low-level tags within each high-level tag;
calculating document sentiment by summing sentiment for the high-level tags; and
storing each calculated sentiment value.

14. The method of claim 13, wherein the document comprises a SEC filing, and each of the high-level tags and lower-level tags correspond a heading in a SEC form.

15. The method of claim 13, further comprising the steps of:
retrieving stored sentiment for a given tag for a plurality of documents, each of the documents having a different filing date; and
calculating sentiment over time for a filing entity.

16. The method of claim 13, further comprising the steps of:
retrieving stored sentiment for a given tag for a plurality of documents, each of the documents having a different filing entity; and
calculating sentiment across a plurality of filing entities.
